(19) United States
(12) Patent Application Publication
(10) Pub. No.: US 2006/0068324 A1
(43) Pub. Date: Mar. 30, 2006

(54) Positive photosensitive resin and novel dithiol compound

(76) Inventor: Takahito Mita, Ichihara-shi (JP)

Correspondence Address: Melvin I. Stoltz, Esq., 51 Cherry Street, Milford, CT, 06460, US

(21) Appl. No.: 11/235,045

(22) Filed: Sep. 26, 2005

(30) Foreign Application Priority Data
Sep. 27, 2004 (JP) 280353/2004

(51) Int. Cl. G03C 1/76

(52) U.S. Cl. 430/270.1

(57) ABSTRACT

A positive photosensitive resin having, in the high-molecular main chain, a structure represented by the following general formula (1): 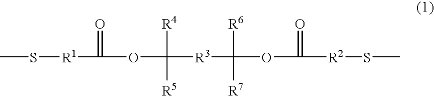
and a dithiol compound represented by the following general formula (2): 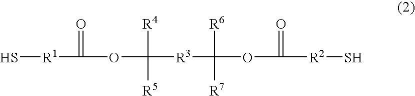 The positive photosensitive resin can alleviate the problems of conventional technique and, when used for formation of a fine patter in semiconductor production, can show a higher resist sensitivity than conventional products and can bring about effects such as reduction in impurities after development. The dithiol compound is novel and extremely suitable for use in production of the positive photosensitive resin.

### BACKGROUND OF THE INVENTION

1. Field of the Invention

The present invention relates to a positive photosensitive resin suitably used in semiconductor lithography and a novel dithiol compound. More particularly, the present invention relates to a positive photosensitive resin which has, in the polymer main chain, a site cleavable by an acid catalyst and accordingly can show a higher resist sensitivity than conventional corresponding resins do and wherein the reduction in size of high-molecule by cleavage can bring about effects such as reduction in impurities after development; as well as to a novel dithiol compound which can be used, for example, as a chain transfer agent in radical polymerization and accordingly is extremely suitable for use in production of the above-mentioned positive photosensitive resin.

2. Background Art

In the lithography employed for production of semiconductor, formation of finer pattern is required with the increase in the integrity of semiconductor. A light source of shorter wavelength is essential for the finer pattern. Currently, a lithography using a KrF excimer laser beam is becoming a main stream and a lithography using a ArF excimer laser beam is being put to practical use. Further, short-wavelength radiation lithography techniques using a F₂ excimer laser beam, an extreme ultraviolet light (EUV), an X-ray, an electron beam or the like are being developed.

As the photo-resist used in semiconductor lithography, chemical amplification type resist developed by Ito et al. Of IBM is essential currently. This chemical amplification type resist has a high sensitivity because an acid-lable protecting group in the resist causes a cleavage reaction in the presence of an acid catalyst.

As specific examples of the resist polymer containing a repeating unit having an acid-lable protecting group, there are known, in KrF lithography, copolymers containing a repeating unit derived from hydroxystyrene and a repeating unit derived from an acid-lable alkoxystyrene; copolymers containing a repeating unit derived from hydroxystyrene and a repeating unit derived from an acid-lable alkyl (meth)acrylate; and polymers wherein part of the hydroxystyrene-derived repeating unit has been protected with an acetal. In ArF lithography, there are known, for example, copolymers containing a repeating unit derived from a lactone structure-containing (meth)acrylate and a repeating unit derived from an acid-lable alkyl (meth)acrylate.

Each of these copolymers is a chemical amplification type resist having a protecting group which is unstable to an acid and is acid-lable. As the resist pattern is required to become increasingly fine, it is becoming difficult to obtain sufficient resist properties with such a protecting group alone.

Hence, there have been investigated resist polymers obtained by introducing, into the side chain of a copolymer containing a repeating unit having an acid-lable protecting group, an acid-lable crosslink site (e.g. Patent Literatures 1 to 3).

In these polymers, the crosslink is cleaved in the presence of an acid catalyst and thereby the dissolution contrast between exposed portions and unexposed portions is enhanced. However, in production of such polymers, there is used a bi-functional monomer such as diacrylate or the like and a crosslinking reaction takes place at the side chain of polymer main chain; therefore, the polymer obtained has an extremely large molecular weight distribution and is inferior in solubility; moreover, an ultrahigh-molecular polymer tends to be formed and, therefore, even after decomposition by acid, there remains a high-molecular component which is sparingly soluble in an alkali developing solution, which has caused a defect in formation of fine pattern.

In a case (Patent Literature 1) of using, as a resist polymer, a crosslinked polymer having, at the side chain of the polymer main chain, a crosslink site having an acid-unstable acetal skeleton, there has been a tendency of inferior storage stability owing to the high sensitivity to acid.

Patent Literature 1: JP-A-2001-98034

Patent Literature 2: JP-A-2000-214587

Patent Literature 3: JP-A-2001-106737

### DISCLOSURE OF THE INVENTION

The present invention has been made in view of the above background and aims at providing a positive photosensitive resin which is used in formation of a fine pattern in semiconductor production, has an acid-lable structure in the polymer main chain and accordingly shows a higher resist sensitivity than conventional products; a resist composition containing the positive photosensitive resin; and a novel dithiol compound extremely highly suitable for use in production of a positive photosensitive resin which causes no formation of ultrahigh-molecular component unlike conventional polymers of side chain crosslink type and which has a narrow molecular weight distribution.

The present invention comprises the following claims.

1. A positive photosensitive resin which has an acid-lable protecting group and, when the group is cleaved by the action of an acid, has an increased solubility in an alkali developing solution, characterized by having, in the polymer main chain, a structure represented by the following general formula (1): 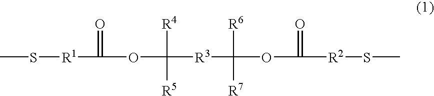
(wherein R¹ and R² are each a straight chain or branched chain bi-valent saturated hydrocarbon group of 2 to 3 carbon atoms, R³ is a straight chain or branched chain bi-valent saturated hydrocarbon group of 2 to 5 carbon atoms, and R⁴ to R⁷ are same or different mono-valent saturated hydrocarbon groups of 1 to 4 carbon atoms).

2. A positive photosensitive resin according to claim 1, which is a copolymer containing at least a phenolic hydroxyl group-containing repeating unit.

3. A positive photosensitive resin according to claim 1 or 2, which is a copolymer containing at least a repeating unit of a (meth)acrylate derivative having an alicyclic skeleton.

4. A positive photosensitive resin according to any of claims 1 to 3, which is a copolymer containing at least a repeating unit of a (meth)acrylate derivative having a lactone skeleton.

5. A dithiol compound represented by the following general formula (2): 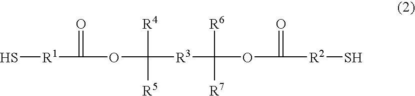
(wherein R¹ and R² are each a straight chain or branched chain bi-valent saturated hydrocarbon group of 2 to 3 carbon atoms, R³ is a straight chain or branched chain bi-valent saturated hydrocarbon group of 2 to 5 carbon atoms, and R⁴ to R⁷ are same or different mono-valent saturated hydrocarbon groups of 1 to 4 carbon atoms).

6. A process for producing a positive photosensitive resin set forth in any of claims 1 to 4, characterized by polymerizing raw material monomers in the presence of a dithiol compound represented by the above general formula (2).

7. A resist composition comprising at least a resin set forth in any of claims 1 to 4 and a photo-acid generator.

The positive photosensitive resin of the present invention has, in the polymer main chain, a site cleavable by an acid catalyst, and accordingly shows a high dissolution contrast between exposed portions and unexposed portions and can show a higher resist sensitivity than conventional products. Further in the present positive photosensitive resin, since the polymer main chain is cleaved and thereby the size of high molecule is reduced, there can be expected reduction in impurities after development and improvement in line edge roughness brought about by flattening of resist pattern in the interface between exposed portions and unexposed portions.

Meanwhile, the novel dithiol compound of the present invention can be used as a chain transfer agent in radical polymerization or as a polymerization initiator in redox polymerization; therefore, it is extremely suitable for use in production of the above-mentioned positive photosensitive resin of the present invention.

Incidentally, there has been no attempt of introducing, into the polymer main chain of a polymer, a structure cleavable by an acid catalyst. By introducing such a structure, it is possible to obtain a positive photosensitive resin which forms no ultrahigh-molecular component and has a narrow molecular weight distribution. By using such a positive photosensitive resin in semiconductor lithography, there can be obtained a positive photoresist which is little in defect caused by insoluble component and has a significantly improved sensitivity.

### DETAILED DESCRIPTION OF THE INVENTION

The positive photosensitive resin of the present invention has an acid-lable protecting group and, when the group is cleaved by the action of an acid, has an increased solubility in an alkali developing solution, and is characterized by having, in the polymer main chain, a structure represented by the following general formula (1): 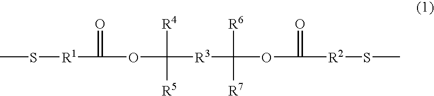
(wherein R¹ and R² are each a straight chain or branched chain bi-valent saturated hydrocarbon group of 2 to 3 carbon atoms, R³ is a straight chain or branched chain bi-valent saturated hydrocarbon group of 2 to 5 carbon atoms, and R⁴ to R⁷ are same or different mono-valent saturated hydrocarbon groups and are each a methyl group, an ethyl group, a propyl group or an iso-butyl group).

As specific examples of the structure of the general formula (1), there can be mentioned the following structures.

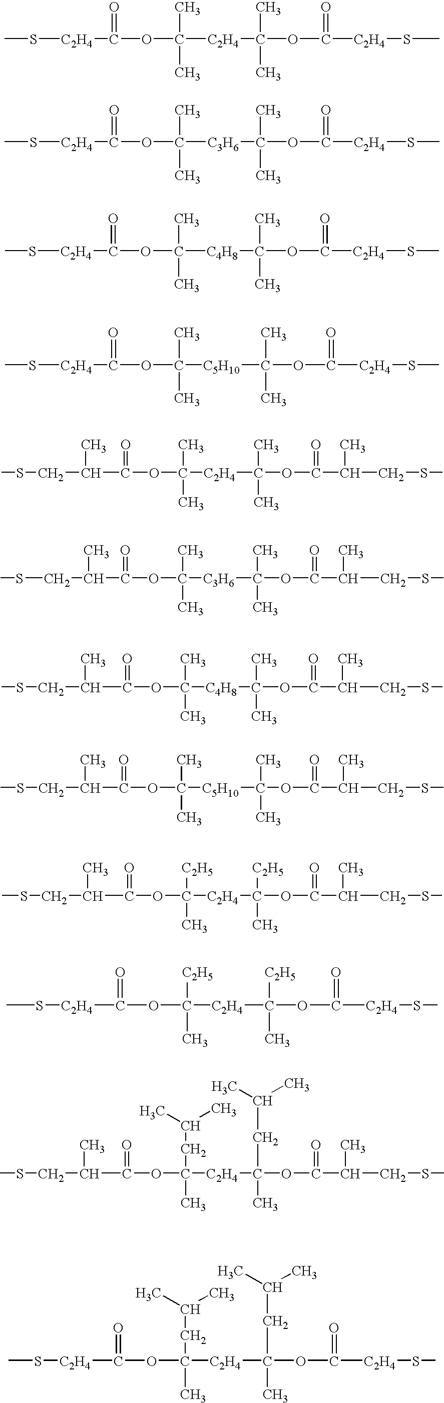

In the positive photosensitive resin of the present invention, when the content of the structure represented by the general formula (1) is too small, the above-mentioned improvement in resist sensitivity is insufficient. Therefore, the content of the structure represented by the general formula (1) is preferably 0.1 mol % or more, more preferably 0.5 mol % or more relative to the total monomer units contained in the resin.

In order to allow the content of the structure represented by the general formula (1) to fall in the above range, the amount of the dithiol compound of the present invention used in production of the resin of the present invention is selected preferably at 0.1 mol or more, more preferably at 0.5 mol or more relative to 100 mol of the raw material monomers. Incidentally, as the use amount of the dithiol compound of the present invention is larger, the content of the structure represented by the general formula (1) in the resin of the present invention is larger but the molecular weight of the copolymer obtained is smaller. Therefore, the use amount of the dithiol compound is selected so that a copolymer of desired molecular weight can be obtained.

The weight-average molecular weight of the positive photosensitive resin of the present invention is preferably 2,000 to 40,000, more preferably 3,000 to 30,000 because too large a molecular weight results in low solubility in the solvent used for coating film formation or in alkali developing solution and too small a molecular weight results in inferior properties of coating film.

As to the raw material monomers used in production of the positive photosensitive resin of the present invention, there is no particular restriction as long as they are polymerizable compounds (monomers) each having ethylenic double bond. In order for the positive photosensitive resin of the present invention to be a positive photosensitive resin which has an acid-lable protecting group and, when the group is cleaved by the action of an acid, has an increased solubility in an alkali developing solution, the resin needs to contain, as essential components, at least a repeating unit (A) having a structure that is cleaved by the action of an acid and comes to have an increased solubility in an alkali developing solution and a repeating unit (B) having a polar group for high adhesivity to substrate, and further contains, as necessary, a repeating unit (C) having a non-polar structure for controlled solubility in resist solvent as well as in alkali developing solution.

The repeating unit (A) having a structure that is cleaved by the action of an acid and comes to have an increased solubility in an alkali developing solution, means a structure generally used in conventional resists and can be obtained by polymerizing a monomer having a structure that is cleaved by the action of an acid and comes to have an increased solubility in an alkali developing solution, or by polymerizing a monomer having an alkali-soluble structure and then protecting the alkali-soluble group of the resulting polymer with an acid-lable group.

As the monomer having a structure that is cleaved by the action of an acid and comes to have an increased solubility in an alkali developing solution, there can be mentioned a compound having an alkali-soluble group protected with an acid-lable group. Examples of such a compound include compounds having a phenolic hydroxyl group, carboxyl group or hydroxyfluoroalkyl group, protected with an acid-lable group.

As specific examples of the monomer having an alkali-soluble group, there can be mentioned hydroxystyrenes such as p-hydroxystyrene, m-hydroxystyrene, p-hydroxy-α-methylstyrene and the like; carboxylic acids having ethylenic double bond, such as acrylic acid, methacrylic acid, trifluoromethylacrylic acid, 5-norbornene-2-carboxylic acid, 2-trifluoromethyl-5-norbornene-2-carboxylic acid, carboxytetracyclo[4.4.0.1^{2,5}.1^{7,10}]dodecyl methacrylate and the like; and compounds having a hydroxyfluoroalkyl group, such as p-(2-hydroxy-1,1,1,3,3,3-hexafluoro-2-propyl)styrene, 2-(4-(2-hydroxy-1,1,1,3,3,3-hexafluoro-2-propyl)cyclohexyl)-1,1,1,3,3,3-hexafluoropropyl acrylate, 2-(4-(2-hydroxy-1,1,1,3,3,3-hexafluoro-2-propyl)cyclohexyl)-1,1,1,3,3,3-hexafluoropropyl trifluoromethyl acrylate, 5-(2-hydroxy-1,1,1,3,3,3-hexafluoro-2-propyl)methyl-2-norbornene and the like.

As specific examples of the acid-lable protecting group, there can be mentioned saturated hydrocarbon groups such as tert-butyl group, tert-amyl group, 1-methyl-1-cyclopentyl group, 1-ethyl-1-cyclopentyl group, 1-methyl-1-cyclohexyl group, 1-ethyl-1-cyclohexyl group, 2-methyl-2-adamantyl group, 2-ethyl-2-adamantyl group, 2-propyl-2-adamantyl group, 2-(1-adamantyl)-2-propyl group, 8-methyl-8-tricyclo[5.2.1.0^{2,6}]decanyl group, 8-ethyl-8-tricyclo[5.2.1.0^{2,6}]decanyl group, 8-methyl-8-tetracyclo[4.4.0.1^{2,5}.1^{7,10}]dodecanyl group, 8-ethyl-8-tetracyclo[4.4.0.1^{2,5}.1^{7,10}]dodecanyl group and the like; and oxygen-containing hydrocarbon groups such as 1-methoxyethyl group, 1-ethoxyethyl group, 1-iso-propoxyethyl group, 1-n-butoxyethyl group, 1-tert-butoxyethyl group, 1-cyclopentyloxyethyl group, 1-cyclohexyloxyethyl group, 1-tricyclo[5.2.1.0^{2,6}]decanyloxyethyl group, 1-methoxymethyl group, 2-ethoxymethyl group, 1-iso-propoxymethyl group, 1-n-butoxymethyl group, 1-tert-butoxymethyl group, 1-cyclopentyloxymethyl group, 1-cyclohexyloxymethyl group, 1-tricyclo[5.2.1.0^{2,6}]decanyloxymethyl group, tert-butoxycarbonyl group and the like.

When a monomer having an alkali-soluble structure is polymerized and then the alkali-soluble group of the resulting polymer is protected with an acid-lable group, the above-mentioned compound having an alkali-soluble group is polymerized and then the resulting polymer is reacted with a compound such as vinyl ether, halogenated alkyl ether or the like in the presence of an acid catalyst, whereby an acid-lable protecting group can be introduced into the polymer. As the acid catalyst used in the reaction, there can be mentioned, for example, p-toluenesulfonic acid, trifluoroacetic acid and a strongly acidic ion exchange resin.

Meanwhile, as the monomer capable of giving the repeating unit (B) having a polar group for high adhesivity to substrate, there can be mentioned, for example, compounds having, as a polar group, phenolic hydroxyl group, carboxyl group or hydroxyalkyl group. As specific examples of such compounds, there can be mentioned the hydroxystyrenes, carboxylic acids having ethylenic double bond and polymerizable compounds having a hydroxyfluoroalkyl group, all mentioned above as the monomer having an alkali-soluble group; monomers obtained by substitution of the above monomers by a polar group; and monomers wherein an alicyclic structure such as norbornene ring, tetracyclododecene ring or the like is bonded with a polar group.

As the polar group introduced into the repeating unit (B), there are particularly preferred polar groups having a lactone structure and, as such polar groups, there can be mentioned, for example, substituents containing a lactone structure such as γ-butyrolactone, γ-valerolactone, δ-valerolactone, 1,3-cyclohexanecarbolactone, 2,6-norbornanecarbolactone, 4-oxatricyclo[5.2.1.0^{2,6}]decane-3-one, mevalonic acid δ-lactone and the like. As the polar groups other than those of lactone structure, there can be mentioned, for example, hydroxyalkyl groups such as hydroxymethyl group, hydroxyethyl group, hydroxypropyl group, 3-hydroxy-1-adamantyl group and the like.

As the monomer for giving the repeating unit (C) (as necessary contained in the present positive photosensitive resin) having a non-polar substituent for controlled solubility in resist solvent as well as in alkali developing solution, there can be mentioned, for example, compounds having a substituted or unsubstituted alkyl or aryl group containing no polar group, or having a polar group protected with a non-polar, acid-unlable group. As specific examples, there can be mentioned styrenes such as styrene, α-methylstyrene, p-methylstyrene and the like; ester compounds wherein an ethylenic double bond-containing carboxylic acid (e.g. acrylic acid, methacrylic acid, trifluoromethylacrylic acid, norbornenecarboxylic acid, 2-trifluoromethylnorbornenecarboxylic acid or carboxytetracyclo[4.4.0.1^{2,5}.1^{7,10}]dodecyl methacrylate) is substituted by an acid-stable, non-polar group; and ethylenic double bond-containing, alicyclic hydrocarbon compounds such as norbornene, tetracyclododecene and the like. As examples of the above-mentioned acid-stable, non-polar group for substitution of carboxylic acid for ester formation, there can be mentioned, for example, methyl group, ethyl group, cyclopentyl group, cyclohexyl group, isobornyl group, tricyclo[5.2.1.0^{2,6}]decanyl group, 2-adamantyl group and tetracyclo[4.4.0.1^{2,5}.1^{7,10}]dodecyl group.

At least one kind of these monomers can be used for each of the repeating units (A), (B) and (C). The ratio of these repeating units in the photosensitive resin obtained can be selected so that the basic properties of resist are not impaired. In general, the proportion of the repeating unit (A) is preferably 10 to 70 mol %, more preferably 10 to 60 mol %. The proportion of the repeating unit (B) is preferably 30 to 90 mol %, more preferably 40 to 90 mol %. With respect to the monomer units having the same polar group, the proportion of the repeating unit (B) is preferably 70 mol % or less. The proportion of the repeating unit (C) is preferably 0 to 50 mol %, more preferably 0 to 40 mol %.

The above-mentioned positive photosensitive resin of the present invention can be produced by polymerizing raw material monomers in the presence of a novel dithiol compound represented by the following general formula (2), specifically by using the novel dithiol compound of the present invention as a chain transfer agent in radical polymerization or as a polymerization initiator in redox polymerization.

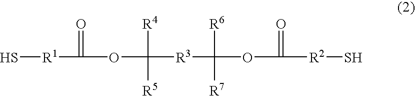

In the above formula, R¹ and R² are each a straight chain or branched chain bi-valent saturated hydrocarbon group of 2 to 3 carbon atoms, R³ is a straight chain or branched chain bi-valent saturated hydrocarbon group of 2 to 5 carbon atoms, and R⁴ to R⁷ are same or different mono-valent saturated hydrocarbon groups and are each a methyl group, an ethyl group, a propyl group or an isopropyl group.

As specific examples of the compound of the general formula (2), there can be shown the following compounds.

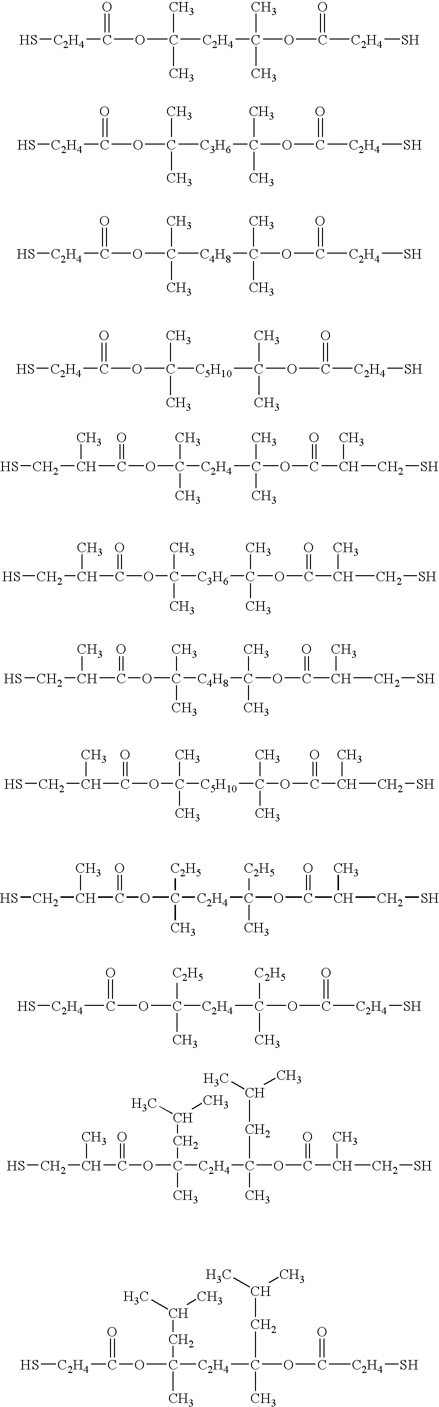

As to the polymerization initiator used when the positive photosensitive resin of the present invention is produced by radical polymerization using the above-mentioned dithiol compound as a chain transfer agent, there is no particular restriction as long as the polymerization initiator is a compound generally used as a radical-generating agent. There can be used, singly or in admixture, for example, azo compounds such as 2,2′-azobisisobutyronitrile, 2,2′-azobis(2-methylbutyronitrile), dimethyl 2,2′-azobisisobutyrate, 1,1′-azobis(cyclohexane-1-carbonitrile), 4,4′-azobis(4-cyanovaleric acid) and the like; and organic peroxides such as decanoyl peroxide, lauroyl peroxide, benzoyl peroxide, bis(3,5,5-trimethylhexanoyl) peroxide, succinic acid peroxide, tert-butyl peroxy-2-ethylhexanoate and the like. The use amount of the polymerization initiator differs depending upon the kinds and amounts of raw material monomers and chain transfer agent used in polymerization reaction and the polymerization conditions such as polymerization temperature and polymerization solvent; therefore, the use amount can not be specified in a given range. However, the use amount is selected generally in a range of 0.01 to 10 mols, preferably in a range of 0.1 to 5 mols relative to mol of the chain transfer agent used.

Meanwhile, as the polymerization initiator used when the positive photosensitive resin of the present invention is produced by redox polymerization using the dithiol compound of the present invention as a polymerization initiator, there can be used, singly or in admixture, for example, salts or complexes of a metal such as vanadium, chromium, manganese, iron, cobalt, nickel or the like. A salt or complex of vanadium having a large ionization potential gap is preferred particularly. As the salt or complex of vanadium, there can be mentioned, for example, vanadium naphthenate, vanadyl stearate, vanadium trisacetylacetonate [V(acac)₃] and vanadyl acetylacetonate [VO(acac)₂]. The use amount of the polymerization initiator differs depending upon the kinds and amounts of raw material monomers and dithiol used in polymerization reaction and the polymerization conditions such as polymerization temperature, polymerization solvent and the like; therefore, the use amount can not be specified in a given range. However, the use amount is selected generally in a range of 0.0001 to 1 mol, preferably in a range of 0.0001 to 0.01 mol relative to mol of the thiol compound used.

The process for production of the positive photosensitive resin of the present invention is preferably a solution polymerization, and it is preferred that raw material monomers, etc. are polymerized in a state that they are dissolved in a polymerization solvent. The solution polymerization can be carried out, for example, by a so-called mixture polymerization method wherein all monomers, a polymerization initiator, a chain transfer agent, etc. are dissolved in a polymerization solvent and heated to a polymerization temperature, and a so-called dropping polymerization method wherein monomers, a polymerization initiator, a chain transfer agent, etc. are dropped partially or totally into a polymerization system heated to a polymerization temperature.

As to the solvent used in the polymerization reaction, there is no particular restriction as long as it is a solvent capable of stably dissolving the raw material monomers, the copolymer obtained, the polymerization initiator and the chain transfer agent. As specific examples of the polymerization solvent, there can be mentioned ketones such as acetone, methyl ethyl ketone, methyl amyl ketone and the like; ethers such as tetrahydrofuran, dioxane, glyme, propylene glycol monomethyl ether and the like; esters such as ethyl acetate, ethyl lactate and the like; ether esters such as propylene glycol methyl ether acetate and the like; and lactones such as γ-butyrolactone and the like. These solvents can be used singly or in admixture.

As to the use amount of the polymerization solvent, there is no particular restriction; however, it is generally 0.5 to 20 parts by weight, preferably 1 to 10 parts by weight relative to 1 part by weight of the monomers. When the use amount of the solvent is too small, there may arise separating-out of the monomers formed. When the use amount is too large, the rate of polymerization reaction may be insufficient.

There is no particular restriction as to the conditions of polymerization reaction. However, in general, the reaction temperature is preferred to be about 60 to 100° C. and the reaction time is preferred to be about 1 to 20 hours.

The polymer obtained by the above polymerization reaction can be purified by dropping the polymerization mixture into a poor solvent or a mixed solvent consisting of a poor solvent and a good solvent, to separate a polymer and, as necessary, washing the polymer to remove the impurities contained therein, such as unreacted monomers, oligomers, polymerization initiator, chain transfer agent, reaction residues thereof and the like. As to the poor solvent, there is no particular restriction as long as it is a solvent in which the copolymer obtained is insoluble, and there can be used, singly or in admixture, for example, water; alcohols such as methanol, isopropanol and the like; and saturated hydrocarbons such as hexane, heptane and the like. As to the good solvent, there is no particular restriction as long as it is a solvent in which the monomers, oligomers, polymerization initiator, chain transfer agent and reaction residues thereof are soluble, and there is preferred the same solvent as used as a polymerization solvent, for simplicity of production steps.

The copolymer after purification contains the solvent used in purification. Therefore, the copolymer after purification is vacuum-dried and then dissolved in a solvent for resist, or the copolymer after purification is once dissolved per se in a resist solvent or in a good solvent such as polymerization solvent or the like and then the solvent(s) other than the resist solvent is (are) distilled off under reduced pressure while the resist solvent is being fed as necessary; in such a way, the copolymer after purification can be converted into a solution for resist.

As to the resist solvent, there is no particular restriction as long as it is a solvent capable of dissolving the copolymer. Ordinarily, the resist solvent is selected in consideration of the boiling point, the influence to semiconductor substrate and coating films, and the absorption of the radiation used in lithography. As examples of the resist solvent generally used, there can be mentioned propylene glycol methyl ether acetate, ethyl lactate, methyl amyl ketone, γ-butyrolactone and cyclohexanone. As to the use amount of the resist solvent, there is no particular restriction and the amount is generally 1 to 20 parts by weight per 1 part by weight of the copolymer.

When the positive photosensitive resin of the present invention is used as a resist, the above-mentioned solution for resist is converted into a resist composition by adding, to the solution, a photo-acid generator and an acid diffusion-suppressing agent (e.g. a nitrogen-containing compound) for prevention of acid diffusion into radiation-unexposed portions. As the photo-acid generator, there can be used those generally used as a raw material for resist, such as onium salt compound, sulfone compound, sulfonic acid ester compound, sulfonimide compound, disulfonyldiazomethane compound and the like. The resist composition may further contain, as necessary, compounds ordinarily used as an additive for resist, such as dissolution prevention agent, sensitizer, dye and the like.

There is no particular restriction as to the proportions of the components (other than resist solvent) in resist composition. In general, the proportion of the polymer concentration is selected in a range of 10 to 50% by mass, the proportion of the radiation-sensitive, acid-generating agent is selected in a range of 0.1 to 10% by mass, and the proportion of the acid diffusion-suppressing agent is selected in a range of 0.001 to 10% by mass.

Meanwhile, the novel dithiol compound of the present invention can be synthesized using a corresponding di(meth)acrylate as a starting raw material. The di(meth)acrylate compound as a raw material can be synthesized, for example, by a method of converting a corresponding diol compound into an acrylic compound using (meth)acrylic acid or (meth)acryloyl chloride, as shown in the following scheme (I).

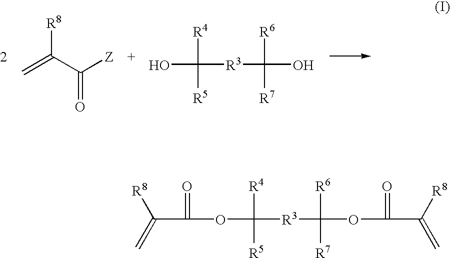

In the scheme (I), Z is a hydrogen atom or a chlorine atom; R⁸ is a hydrogen atom, a methyl group or a halogen-substituted alkyl group; R³ is a bi-valent organic group composed of a branched chain or cyclic saturated hydrocarbon of 0 to 10 carbon atoms; R⁴ to R⁷ are each a mono-valent organic group composed of a straight chain or branched chain or cyclic saturated hydrocarbon of 1 to 10 carbon atoms and may be the same or different.

As the diol compound in the scheme (I), there can be mentioned, for example, 2,5-dimethyl-2,5-hexanediol, 2,6-dimethyl-2,6-hepthanediol, 2,7-dimethyl-2,7-octanediol, 2,8-dimethyl-2,8-nonanediol, 2,9-dimethyl-2,9-decanediol, 2,10-dimethyl-2,10-dodecanediol, 3,6-dimethyl-3,6-octanediol and 2,4,7,9-tetramethyl-4,7-decanediol.

The intended dithiol compound of the present invention can be synthesized, for example, by a method of adding, to the di(meth)acrylate compound obtained by the reaction shown in the above scheme (I), a thioacid such as thioacetic acid, thiopropionic acid or the like and then subjecting the resulting thioacid ester to hydrolysis or alcoholysis, as shown in, for example, the following scheme (II).

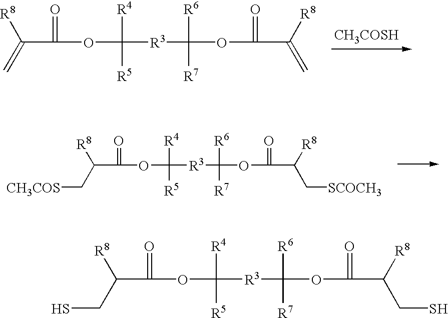

In the scheme (II), R⁸ is a hydrogen atom, a methyl group or a halogen-substituted alkyl group; R³ is a bi-valent organic group composed of a branched chain or cyclic saturated hydrocarbon of 0 to 10 carbon atoms; R⁴ to R⁷ are each a mono-valent organic group composed of a straight chain or branched chain or cyclic saturated hydrocarbon of 1 to 10 carbon atoms and may be the same or different.

In the reaction of the scheme (II), 1 mol of a di(meth)acrylate compound is reacted with ordinarily 2 to 10 mols, preferably 2 to 5 mols of a thioacid (e.g. thioacetic acid or thiopropionic acid; thioacetic acid is shown in the scheme) in the presence of a radical polymerization initiator (e.g. 2,2-azobisisobutyronitrile or peroxide) or a redox catalyst (e.g. vanadium oxide acetylacetonate or vanadium acetylacetonate) ordinarily at 0 to 100° C., preferably 10 to 80° C. ordinarily for 10 minutes to 12 hours, preferably 1 to 8 hours.

A reaction solvent may be used or may not be used. As the reaction solvent when used, there can be mentioned, for example, toluene, benzene, xylene, tetrahydrofuran, dioxane, methyl ethyl ketone, methyl iso-butyl ketone, ethyl acetate, propylene glycol monomethyl ether acetate, methanol, ethanol and isopropanol. As the reaction method, there can be mentioned, for example, a method of feeding total amounts into a reactor and then heating or cooling the mixture to a required temperature, and a method of feeding a thioacid into a reactor and then dropping thereinto a radical polymerization initiator or a redox catalyst and a di(meth)acrylate compound. However, in order to suppress the formation of an oligomer derived from the di(meth)acrylate compound, there is preferred a method of dissolving a radical polymerization initiator or a redox catalyst in a given solvent in a reaction system, heating or cooling the system, then dropping thereinto a di(meth)acrylate compound and a thioacid, and there is more preferred a method of dropping a di(meth)acrylate compound and a thioacid separately.

After the reaction, purification is conducted by a known method such as distillation, recrystallization, column purification or the like, whereby can be obtained a dithioacid ester which is an intermediate for the dithiol compound of the present invention. 1 mol of the dithioacid ester obtained is reacted with 5 to 50 mols, preferably 10 to 30 mols of water or an alcohol (e.g. methanol or ethanol) in the presence of an acid (e.g. hydrochloric acid, sulfuric acid or sulfonic acid) or an alkali (e.g. sodium hydroxide or potassium hydroxide) ordinarily at 0 to 80° C., preferably 50 to 80° C. ordinarily for 1 to 20 hours, preferably 3 to 5 hours; then purification is made by a known method such as distillation, recrystallization, column purification or the like; thereby can be obtained a dithiol compound of the present invention.

The structure of the compound obtained can be confirmed by an instrumental analysis, particularly NMR spectrum.

Next, the present invention is described more specifically by way of Examples. However, the present invention is in no way restricted to these Examples. The average composition of each copolymer obtained was determined from the result of measurement by ¹³C-NMR, and the weight-average molecular weight Mw and polydispersity index Mw/Mn, of each copolymer were determined from the result of measurement by gel permeation chromatography (GPC).

### REACTION EXAMPLE 1

### Synthesis of Compound of the Following Structural Formula (i)

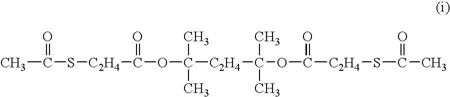

In a four-necked flask provided with a stirrer, a reflux condenser and a dropping device were placed 33 g of methanol and 0.01 g of vanadyl acetylacetonate [VO(acac)₂]. The flask was immersed in an oil bath of 80° C., followed by stirring. Separately, in an Erlenmeyer flask were placed 20 g of 1,1,4,4-trimethyl-1,4-butanediol diacrylate and 30 g of methanol, followed by stirring for 30 minutes for complete dissolution, to obtain a dropping solution 1. In a separate Erlenmeyer flask were placed 18 g of thioacetic acid and 30 g of methanol, followed by stirring for 30 minutes, to obtain a dropping solution 2. Into the four-necked flask immersed in an oil bath were dropped the dropping solution 1 and the dropping solution 2 together in 2 hours and 20 minutes. Then, aging was conducted for 7 hours. After completion of a reaction, the light component was removed under reduced pressure to obtain crude crystals. The crude crystals were recrystallized from hexane to obtain a white solid (I). Yield: 72% in terms of diacrylate.

¹³C-NMR spectrum (solvent: CDCl₃) δ (ppm): 194.8, 170.2, 82.2, 35.1, 34.1, 30.2, 25.9, 24.1

¹H-NMR spectrum (solvent: CDCl₃) δ (ppm): 3.08 (t, 4H), 2.55 (t, 4H), 2.33 (s, 6H), 1.78 (s, 4H), 1.43 (s, 12H)

### EXAMPLE 1

Synthesis of Novel Dithiol Compound (Hereinafter Abbreviated to DMOC) Represented by the Following Structural Formula

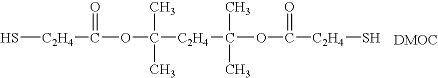

Into a 200-cc test tube were fed 2 g of the dithioacetate compound (I) obtained in the Reaction Example 1, 6 g of methanol and 2 g of sodium hydroxide. The test tube was fitted with a cooling tube and filled with nitrogen inside. Then, the test tube was immersed in an oil bath of 80° C., followed by stirring for 5 hours. The reaction mixture was cooled to room temperature, after which the reaction mixture was placed in a separatory funnel together with 8.5 g of ethyl acetate and 19 g of pure water. The resulting aqueous layer was separated. Then, 20 g of pure water was added to the oily layer for washing and the resulting aqueous layer was separated. This operation was repeated four times. Then, the oily layer was subjected to simple distillation to obtain 560 mg of a white solid in a vacuum of 0.05 mmHg at 180° C. (oil bath). The purity of the white solid was 98 area % by an analysis by liquid chromatography. Yield: 35%

¹³C-NMR spectrum (solvent: CDCl₃) δ (ppm): 172.5 (s), 83.6 (s), 40.6 (t), 35.2 (t), 26.7 (q), 20.5 (t)

¹H-NMR spectrum (solvent: CDCl₃) δ (ppm): 4.83 (br, 2H, —SH), 2.74 (t, 4H, —CH₂—), 2.61 (t, 4H, —CH₂—), 1.91 (s, 4H, —CH₂—), 1.49 (s, 12H, —CH₃)

### EXAMPLE 2

### Synthesis of poly(p-hydroxystyrene-co-tert-butyl acrylate) having acid-cleavable site in main chain

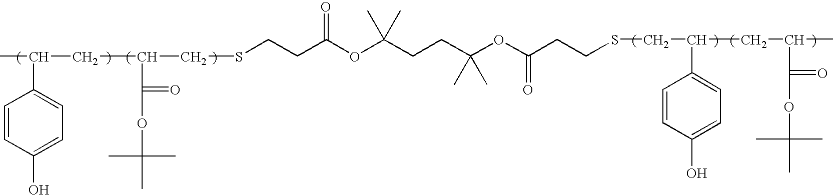

Into a 50-cc Schlenk tube were fed 26.9 g of crude p-hydroxystyrene [23 parts by weight of p-hydroxystyrene (hereinafter abbreviated to PHS), 45 parts by weight of p-ethylphenol, 22 parts by weight of methanol and 10 parts by weight of water] obtained by dehydrogenation of p-ethylphenol, 3.11 g of tert-butyl acrylate (hereinafter abbreviated to BHA), 0.42 g of the dithiol compound (DMOC) obtained in Example 1 and 0.61 g of dimethyl-2,2′-azobisisobutyrate (hereinafter abbreviated to MAIB), followed by stirring at room temperature for 20 minutes for complete dissolution. The Schlenk tube was fitted with a cooling tube and immersed in an oil bath of 70° C., followed by stirring for 6 hours. Then, the Schlenk tube was cooled to room temperature. The resulting polymerization mixture was added into 150 g of toluene to separate a polymer and the supernatant liquid was discarded by decantation. Then, the polymer was re-dissolved in 10 g of acetone; 150 g of toluene was added to re-separate a polymer; the supernatant liquid was discarded by decantation. This operation was conducted once more. Thereafter, the polymer was re-dissolved in 10 g of acetone; 200 g of hexane was added to separate a polymer; the supernatant liquid was discarded by decantation. The resulting cake-like precipitate was dried under reduced pressure (10 Torr) at 60° C. for 3 days to obtain 9 g of a light yellow polymer powder. The DMOC content in the polymer and the average composition, weight-average molecular weight and polydispersity index of the polymer are shown in Table 1.

### EXAMPLE 3

### Synthesis of poly(5-methacryloyloxy-2,6-norbornanecarbolactone-co-2-methyl-2-admantylmethacrylate) having acid-cleavable site in main chain

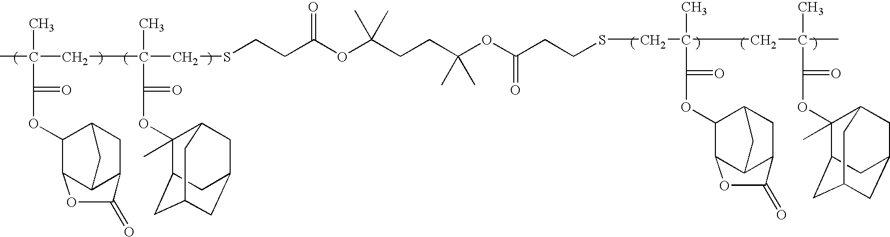

In a 50-cc Schlenk tube were placed 4.44 g of 5-methacryloyloxy-2,6-norbornanecarbolactone (hereinafter abbreviated to NLM), 4.69 g of 2-methyl-2-admantylmethacrylate (hereinafter abbreviated to MAM), 27.4 g of tetrahydrofuran, 0.26 g of DMOC and 0.18 g of MAIB, followed by stirring at room temperature for 20 minutes for complete dissolution. The Schlenk tube was fitted with a cooling tube and immersed in an oil bath of 70° C., followed by stirring for 6 hours. The Schlenk tube was cooled to room temperature. The resulting polymerization mixture was added into 180 g of methanol to separate a polymer. The polymer was filtered through a filter paper having pores of 1 micron. The resulting wet cake-like polymer was added into 180 g of methanol, followed by stirring and washing. The methanol was separated by filtration. This operation was conducted twice. The resulting polymer was dried at 10 Torr at 60° C. for 3 days to obtain 6.5 g of a white polymer. The DMOC content in the polymer and the average composition, weight-average molecular weight and polydispersity index of the polymer are shown in Table 1.

### EXAMPLE 4

### Synthesis of poly(γ-butyrolactone-2-ylmethacrylate-co-tert-butylmethacrylate) having acid-cleavable site in main chain

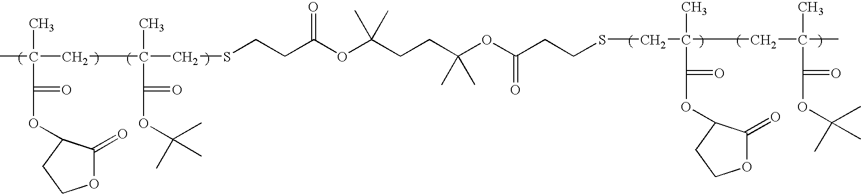

In a 50-cc Schlenk tube were placed 5.10 g of γ-butyrolactone-2-ylmethacrylate (hereinafter abbreviated to GBM), 4.26 g of tert-butyl methacrylate (hereinafter abbreviated to TBMA), 28.1 g of tetrahydrofuran, 0.39 g of DMOC and 0.28 g of MAIB, followed by stirring at room temperature for 20 minutes for complete dissolution. The Schlenk tube was fitted with a cooling tube and immersed in an oil bath of 70° C., followed by stirring for 6 hours. The Schlenk tube was cooled to room temperature. The resulting polymerization mixture was added into 180 g of methanol to separate a polymer. The polymer was filtered through a filter paper having pores of 1 micron. The resulting wet cake-like polymer was added into 180 g of methanol, followed by stirring and washing. The methanol was separated by filtration. This operation was conducted twice. The resulting polymer was dried at 10 Torr at 60° C. for 3 days to obtain 4.5 g of a white polymer. The DMOC content in the polymer and the average composition, weight-average molecular weight and polydispersity index of the polymer are shown in Table 1.

### COMPARATIVE EXAMPLE 1

### Synthesis of poly(p-hydroxystyrene-co-tert-butylacrylate) having no acid-cleavable site in main chain

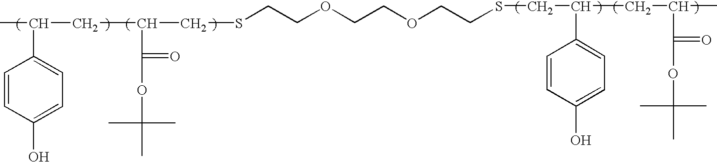

7 g of a polymer was synthesized in the same manner as in Example 2 except that the DMOC used as a chain transfer agent was changed to 0.24 g of 3,6-dioxa-1,8-octanedithiol (hereinafter abbreviated to DOODT). The DOODT content in the polymer and the average composition, weight-average molecular weight and polydispersity index of the polymer are shown in Table 1.

### COMPARATIVE EXAMPLE 2

### Synthesis of poly(5-methacryloyloxy-2,6-norbornanecarbolactone-co-2-methyl-2-adamantylmethacrylate) having no acid-cleavable site in main chain

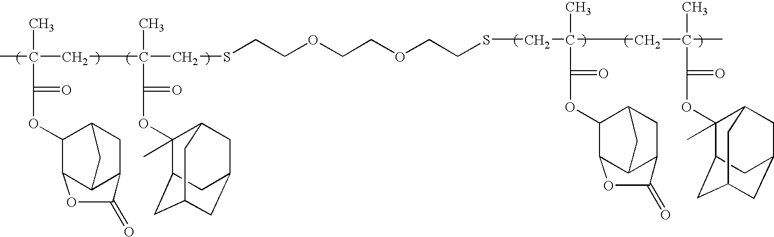

7 g of a polymer was synthesized in the same manner as in Example 3 except that the DMOC used as a chain transfer agent was changed to 0.15 g of DOODT. The DOODT content in the polymer and the average composition, weight-average molecular weight and polydispersity index of the polymer are shown in Table 1.

### COMPARATIVE EXAMPLE 3

### Synthesis of poly(γ-butyrolactone-2-ylmethacrylate-co-tert-butylmethacrylate) having no acid-cleavable site in main chain

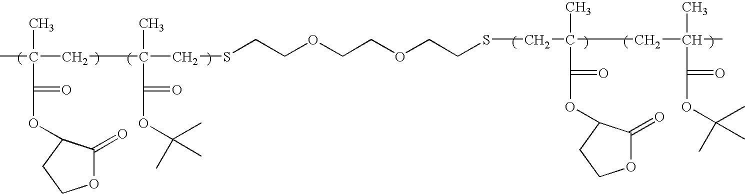

4 g of a polymer was synthesized in the same manner as in Example 4 except that the DMOC used as a chain transfer agent was changed to 0.22 g of DOODT. The DOODT content in the polymer and the average composition, weight-average molecular weight and polydispersity index of the polymer are shown in Table 1.

TABLE 1

| | Content of chain | | | | | | | | | |
|---|---|---|---|---|---|---|---|---|---|---|
| | transfer agent (mol %) | | Average composition (mol %) | | | | | | Molecular weight | |
| | DMOC | DOODT | PHS | TBA | NLM | MAM | GBM | TMBA | Mw | Mw/Mn |
| Example 2 | 1.1 | — | 65 | 35 | — | — | — | — | 19,500 | 2.8 |
| Comp. Example 1 | — | 1.2 | 65 | 35 | — | — | — | — | 20,000 | 3.0 |
| Example 3 | 1.9 | — | — | — | 54 | 46 | — | — | 11,000 | 1.4 |
| Comp. Example 2 | — | 2.0 | — | — | 54 | 46 | — | — | 11,000 | 1.4 |
| Example 4 | 1.3 | — | — | — | — | — | 59 | 41 | 7,800 | 1.5 |
| Comp. Example 1 | — | 1.3 | — | — | — | — | 59 | 41 | 7,500 | 1.5 |

(Evaluation of Sensitivity of Resist)

1 g of the polymer obtained in Example 2 (a positive photosensitive resin of the present invention) and 0.01 g of a photo-acid generator (5-norbornene-2,3-dicarboxyimidyl trifluoromethanesulfonate) were dissolved in 5.8 g of propylene glycol monomethyl ether acetate. The resulting solution was filtered through a 0.2-μm filter made of Teflon (registered trade mark) to prepare a resist composition. Then, the resist composition was spin-coated on a silicon wafer of 100 mm in diameter beforehand subjected to a hexamethyldisilazane treatment, followed by baking on a hot plate at 130° C. for 60 seconds, to form a thin resist film of 0.6 μm in thickness on the wafer. The resist film-formed wafer was placed in contact exposure tester, and a mask obtained by drawing a pattern on a quartz plate with chromium was tightly adhered onto the resist film. A 248-nm ultraviolet light was applied to the resist film through the mask. Immediately thereafter, post-baking was conducted on a hot plate at 150° C. for 60 seconds; development was conducted by 30-seconds immersion in a 23° C. aqueous solution (developing solution) containing 0.26 mol/l of tetramethylammonium hydride (TMAH); successively, 60-seconds rinsing with pure water was conducted. As a result, there was obtained a positive pattern in which only the exposed portions of the resist film had been dissolved in and removed by the developing solution. The same operation was conducted also for the resist compositions obtained from the resins obtained in Examples 3 and 4 and Comparative Examples 1, 2 and 3. The results are shown in Table 2.

TABLE 2

| | | | Alkali concentration | | |
|---|---|---|---|---|---|
| | Film thickness | Time of post baking | in developing solution | Development time | Sensitivity |
| | (μm) | (sec) | (mol/l) | (sec) | (mJ/cm²) |
| Resist containing the main chain- | 0.6 | 60 | 0.26 | 30 | 1 |
| cleavable resin obtained in Example 2 | | | | | |
| Resist containing the resin obtained | 0.6 | 60 | 0.26 | 30 | 3 |
| in Comparative Example 1 | | | | | |
| Resist containing the main chain- | 0.5 | 120 | 0.38 | 60 | 40 |
| cleavable resin obtained in Example 3 | | | | | |
| Resist containing the resin obtained | 0.5 | 120 | 0.38 | 60 | 140 |
| in Comparative Example 2 | | | | | |
| Resist containing the main chain- | 0.5 | 120 | 0.38 | 60 | 140 |
| cleavable resin obtained in Example 4 | | | | | |
| Resist containing the resin obtained | 0.5 | 120 | 0.38 | 60 | 350 |
| in Comparative Example 3 | | | | | |

As is clear from the results of Table 2, the resists each containing one of the main chain-acid-cleavable resins obtained in Examples showed significantly improved resist sensitivities, as compared with the resists each containing a main chain-acid-uncleavable resin whose properties were the same as those of the resins obtained in Examples.

1. A positive photosensitive resin which has an acid-lable protecting group and, when the group is cleaved by the action of an acid, has an increased solubility in an alkali developing solution, characterized by having, in the polymer main chain, a structure represented by the following general formula (1): 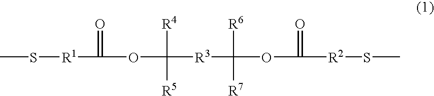
(wherein R¹ and R² are each a straight chain or branched chain bi-valent saturated hydrocarbon group of 2 to 3 carbon atoms, R³ is a straight chain or branched chain bi-valent saturated hydrocarbon group of 2 to 5 carbon atoms, and R⁴ to R⁷ are same or different mono-valent saturated hydrocarbon groups of 1 to 4 carbon atoms).

2. A positive photosensitive resin defined in claim 1, which is a copolymer containing at least a phenolic hydroxyl group-containing repeating unit.

3. A positive photosensitive resin defined in claim 1, which is a copolymer containing at least a repeating unit of a (meth)acrylate derivative having an alicyclic skeleton.

4. A positive photosensitive resin defined in claim 1, which is a copolymer containing at least a repeating unit of a (meth)acrylate derivative having a lactone skeleton.

5. A dithiol compound represented by the following general formula (2): 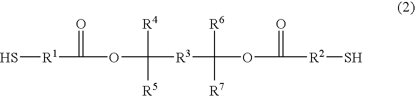
(wherein R¹ and R² are each a straight chain or branched chain bi-valent saturated hydrocarbon group of 2 to 3 carbon atoms, R³ is a straight chain or branched chain bi-valent saturated hydrocarbon group of 2 to 5 carbon atoms, and R⁴ to R⁷ are same or different mono-valent saturated hydrocarbon groups of 1 to 4 carbon atoms).

6. A process for producing a positive photosensitive resin defined in claim 1, characterized by polymerizing raw material monomers in the presence of a dithiol compound represented by the following general formula (2): 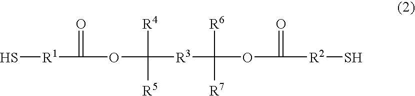
(wherein R¹ and R² are each a straight chain or branched chain i-valent saturated hydrocarbon group of 2 to 3 carbon atoms, R³ is a straight chain or branched chain bi-valent saturated hydrocarbon group of 2 to 5 carbon atoms, and R⁴ to R⁷ are same or different mono-valent saturated hydrocarbon groups of 1 to 4 carbon atoms).

7. A resist composition defined in claim 1 comprising at least a resin and a photo-acid generator.
